(19) United States
(12) Patent Application Publication
(10) Pub. No.: US 2018/0013520 A1
(43) Pub. Date: Jan. 11, 2018

(54) METHOD AND USER EQUIPMENT FOR HYBRID AUTOMATIC REPEAT REQUEST ENTITY MANAGEMENT

(71) Applicants: Ningjuan CHANG, Shanghai (CN); Sharp Kabushiki Kaisha, Sakai City, Osaka (JP)

(72) Inventors: NINGJUAN CHANG, Shanghai (CN); QI JIANG, Shanghai (CN); RENMAO LIU, Shanghai (CN)

(21) Appl. No.: 15/544,992

(22) PCT Filed: Jan. 19, 2016
(86) PCT No.: PCT/CN2016/071348

§ 371 Date: Jul. 20, 2017

(30) Foreign Application Priority Data
Jan. 21, 2015 (CN) 201510031121.7

(51) Int. Cl. H04L 1/18; H04W 72/12; H04W 76/06

(52) U.S. Cl. CPC H04L 1/1812; H04W 76/068; H04L 1/1874; H04W 72/1289; H04W 76/064

(57) ABSTRACT

The present application provides an HARQ entity management method which is executed by a user equipment or a medium access control (MAC) entity in the user equipment. The HARQ entity management method includes: initializing an HARQ entity corresponding to a secondary serving cell group when a first secondary cell in a secondary serving cell group is added, or when the secondary serving cell group is added. The method may further include: receiving a secondary serving cell adding command from a base station. The present application also provides a corresponding user equipment.

### TECHNICAL FIELD

The present invention relates to the technical field of wireless communications. More particularly, the present invention relates to a hybrid automatic repeat request (HARQ) entity management method and a corresponding user equipment.

### BACKGROUND

Modern wireless mobile communication systems present two significant characteristics: one is broadband and high speed, for example, a bandwidth of a fourth-generation wireless mobile communication system can reach 100 MHz, and a down-link speed reaches up to 1 Gbps; and the other one is the mobile Internet, which promotes emerging businesses such as mobile Internet access, mobile phone video on demand, on-line navigation, and the like. The two characteristics put forward relatively high requirements on the wireless mobile communication technology, mainly including: ultrahigh-speed wireless transmission, inter-region interference suppression, reliable signal transmission when in motion, distributive-type/intensive-type signal processing, and the like. In future enhanced fourth-generation and fifth-generation wireless mobile communication systems, in order to meet the above-mentioned development requirements, various corresponding key techniques are beginning to be proposed and demonstrated, which is worthy of more and more attention within the research personnel in the art.

In October, 2007, the International Telecommunications Union (ITU) ratified a Worldwide Interoperability for Microwave Access (WiMax) to become a fourth 3G system standard. The event happening during the last stage of a 3G era is, in reality, a preview of a 4G standard battle. In fact, since 2005, in order to meet the challenge of a wireless Internet Protocol (IP) technical flow representative of a wireless local area network and the WiMax, a 3GPP organization has initiated a brand-new system upgrade, namely standardization of a Long Term Evolution (LTE) system. This is a Quasi-4G system based on Orthogonal Frequency Division Multiplexing (OFDM). The first version was pushed out at the beginning of 2009, and began to be commercially available in succession all over the world in 2010. Meanwhile, the 3GPP organization had initiated standardization of the 4G wireless mobile communication system since the first half year of 2008. The system is called the Long Term Evolution Advanced (LTE-A) system. A key standardization document of a physical layer process of the system had been completed at the beginning of 2011. In November, 2011, the ITU announced, in Chongqing, China, that the LTE-A system and the WiMax system are two official standards of the 4G system. At present, a commercial process of the LTE-A system is being developed gradually around the world.

According to challenges in the coming ten years, the following development demands are substantial for an enhanced 4G wireless mobile communication system:
a higher wireless broadband speed is required, and optimization of local cell hot spot regions is emphasized;
the user experience is further improved, particularly it is necessary to optimize communication services of cell boundary regions;
in view of it being impossible to expand clear bands 1000 times, it is necessary to continue researching a new technology capable of improving band utilization efficiency;
high-frequency bands (5 GHz or greater) will certainly come into use to obtain a larger communication bandwidth;
existing networks (2G/3G/4G, WLAN, WiMax, and the like.) cooperate to share data traffic;
for different services, applications and service are specifically optimized;
a system capability of supporting large-scale machine communications is supported;
network planning and distribution are flexible, smart and inexpensive;
a solution is designed to save the power consumption of a network and the battery consumption of a user terminal.

In a traditional 3GPP LTE system, data transmission is performed only over licensed bands/carriers. However, with the rapid increase of service traffic, the licensed bands/carriers may have particular difficulty meeting demands of the increased service traffic in hot spot regions of some cities. A new research subject, i.e. research (RP-132085) on unlicensed bands/carriers was discussed at the 3GPP ran #62 Conference. A main object was to research the utilization of non-standalone deployment of LTE on the unlicensed band. The so-called non-standalone refers to that the communication on the unlicensed band correlates with a serving cell on the licensed band to be used and cannot independently serve a user. A direct method is to continue to use a carrier aggregation way in the LTE system as far as possible, i.e. the licensed band is deployed as a primary component carrier (PCC) of a serving base station, and a corresponding cell is called a primary cell (PCell); and the unlicensed band is deployed as a secondary component carrier (SCC) of the serving base station, and a corresponding cell is called a secondary cell (SCell).

For a working style of the unlicensed band, there is currently a conventional approach, i.e. listen before talk (LBT). However, a channel occupancy time window of the LBT is limited in Europe and Japan, with a maximum channel occupancy time window of the LBT in Europe being 13 ms, and the channel occupancy time window of the LBT in Japan being less than 4 ms. Based on this, a corresponding complete HARQ (hybrid automatic repeat request) process (for example, a primary transmission plus three retransmissions) in the existing LTE system cannot be completed in one COTW. Based on the operation characteristics of the unlicensed band system, i.e. all sites compete for the corresponding channel resource, when the primary transmission is completed, the subsequent retransmission cannot be ensured to be carried out on the same unlicensed carriers. For this problem, there is a solution employing the inter-carrier dynamic HARQ transmission, that is, for a data block, the primary transmission and the retransmission can be carried out on different carriers so as to complete an entire HARQ process within a time required by the quality of service (QoS) corresponding to the data block.

### SUMMARY

For the inter-carrier dynamic HARQ transmission described in the above background, there is an implementation method in which multiple carriers share an HARQ entity, the HARQ entity can flexibly allocate the HARQ primary transmission and retransmission of a transmission block (TB) in an HARQ buffer to be carried out on different carriers based on the availability of resources on different carriers. In the existing LTE mechanism, one serving cell corresponds to an independent HARQ entity, a corresponding user equipment side HARQ entity management method is also based on this. When the above multi-carrier HARQ entity shares transmission, the HARQ entity management method in the existing mechanism may cause errors in the treatment of the HARQ entity or the corresponding HARQ buffer, thus this is the problem that the present invention focuses on.

For the above problem, based on the LTE and an LTE-A network, the present invention provides an HARQ entity management method and apparatus supporting the dynamic HARQ transmission configuration. Through the HARQ entity management method, the user equipment can perform corresponding processing for the HARQ entity when the shared HARQ entity is configured, so that the data loss caused by the wrong operation can be avoided.

The method of the present invention is not limited to a communication apparatus and system operated on the unlicensed bands/carriers described in the background, and is also suitable for other multi-carrier apparatuses and systems.

According to a first aspect of the present disclosure, provided is an HARQ entity management method which is executed by a user equipment or a medium access control (MAC) entity in the user equipment. The HARQ entity management method includes: initializing an HARQ entity corresponding to a secondary serving cell group when a first secondary cell in a secondary serving cell group is added, or when the secondary serving cell group is added. The method may further include: receiving a secondary serving cell adding command from a base station.

According to a second aspect of the present disclosure, provided is an HARQ entity management method which is executed by a user equipment or a medium access control (MAC) entity in the user equipment. The HARQ entity management method includes: release an HARQ entity corresponding to a secondary serving cell group when a last secondary cell in a secondary serving cell group is released, or when the secondary serving cell group is released. The method may further include: receiving a secondary serving cell release command from a base station.

According to a third aspect of the present disclosure, provided is an HARQ entity management method which is executed by a user equipment or a medium access control (MAC) entity in the user equipment. The HARQ entity management method includes: flushing an HARQ buffer corresponding to a secondary serving cell if the secondary serving cell correlates with a secondary serving cell group and the secondary serving cell is a last activated-state cell in the secondary serving cell or if the secondary serving cell does not correlate with the secondary serving cell group when the secondary serving cell is deactivated. The method may further include: receiving a secondary serving cell deactivation command from a base station; or detecting whether a deactivation timer for the secondary serving cell has timed out.

In the method according to the above three aspects, the secondary cells in the secondary serving cell group share a same HARQ entity. The method may further include: receiving secondary serving cell group indication information from the base station via a radio resource control (RRC) message, wherein the secondary serving cell group indication information is used for indicating an HARQ entity corresponding to the secondary cell.

Referring to the descriptions and accompanying drawings below, specific implementations of the present invention are disclosed in detail, and a way that may be employed by the principle of the present invention is pointed out. It shall be appreciated that the scope of embodiments of the present invention is not limited. Embodiments of the present invention include various changes, modifications and equivalents within the spirit and scope of the attached claims.

Descriptions and/or features of one embodiment can be used in one or more other embodiments in a same or similar way and can be combined with the features in other embodiments or can substitute the features in other embodiments.

It shall be emphasized that the term “comprising/including” used herein refers to the presence of features, parts, steps or components, but the presence or addition of one or more other features, parts, steps or components is not excluded.

### BRIEF DESCRIPTION OF THE DRAWINGS

Aspects of the present invention can be better understood by referring to the following drawings. Parts in the drawings are not drawn to scale, but only used to illustrate the principle of the present invention. In order to conveniently illustrate and describe some portions of the present invention, the corresponding portions in the drawings may be enlarged or minimized.

Elements and features described in one drawing or one embodiment of the present invention can be combined with elements and features illustrated in one or more of the other drawings or embodiments. Furthermore, in the drawings, like reference numerals refer to corresponding parts in several drawubgs and may be used to indicate the corresponding parts used in more than one embodiment.

FIG. 1 is a schematic flowchart illustrating a base station side under the configuration of a multi-carrier shared HARQ entity.

FIG. 2 is a schematic flowchart illustrating a user equipment side under the configuration of the multi-carrier shared HARQ entity.

FIG. 3 is a schematic diagram illustrating information exchange between a base station and a user equipment under the configuration of the multi-carrier shared HARQ entity.

FIG. 4 is a flowchart illustrating a first embodiment of a user equipment side HARQ entity management method according to the present disclosure.

FIG. 5 is a schematic flowchart illustrating a specific implementation of the method illustrated in FIG. 4.

FIG. 6 is a flowchart illustrating a second embodiment of a user equipment side HARQ entity management method according to the present disclosure.

FIG. 7 is a schematic flowchart illustrating the specific implementation of the method illustrated in FIG. 6.

FIG. 8 is a flowchart illustrating a third embodiment of a user equipment side HARQ entity management method according to the present disclosure.

FIG. 9 is a schematic flowchart illustrating the specific implementation of the method illustrated in FIG. 8.

FIG. 10 is a structural schematic diagram illustrating the user equipment according to the present disclosure.

### DETAILED DESCRIPTION

Referring to the drawings, the above descriptions and other features of the present invention will become apparent through the description below. In the description and the drawings, specific embodiments of the present invention are particularly disclosed, which describe some of the embodiments in which the principle of the invention may be employed; and it shall be known that the present invention is not limited to the embodiments described below, but on the contrary, the present invention includes all modifications, variations and equivalents falling within the scope of the attached claims. Furthermore, for the sake of simplicity and convenience, the detail description of the known technology that is not directly correlated with the present invention is omitted, so as to prevent from causing the misunderstanding of the present invention.

A user equipment side HARQ entity management method under a shared HARQ entity configuration mode proposed by the present invention is described below in combination with the drawings and specific embodiments.

Embodiments according to the present invention are specifically described below by using an LTE mobile communication system and subsequent evolved versions thereof as an example application environment. However, it should be pointed out that the present invention is not limited to the following embodiments, but can be applied to other wireless communication systems, for example, a 5G cellular communication system in future.

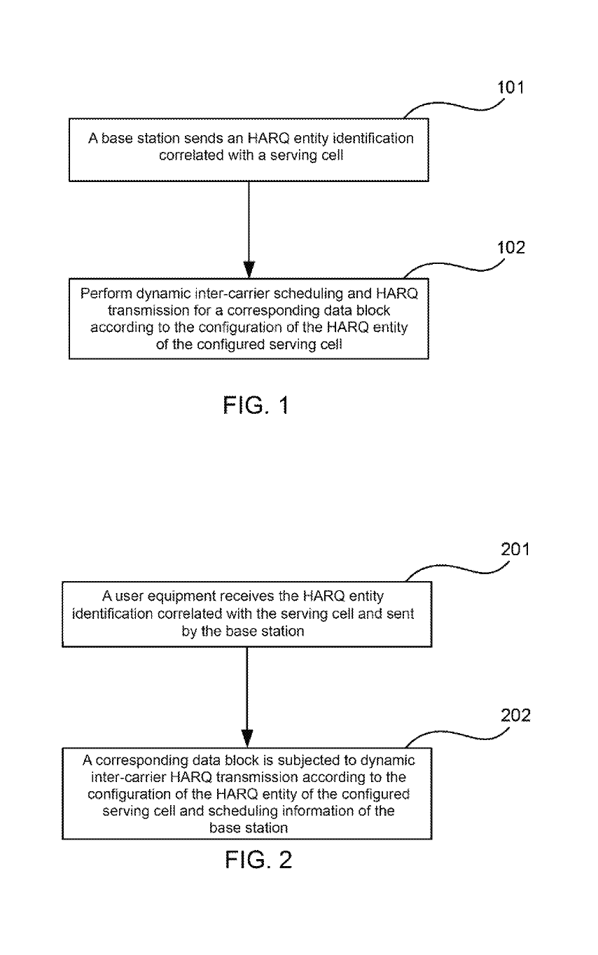

Firstly, the operation of a base station side and a user equipment side and the information exchange between the base station and the user equipment under a shared HARQ entity configuration mode are described with reference to FIG. 1 to FIG. 3.

As illustrated in FIG. 1, the operation at the base station side includes step 101 and step 102.

In step 101, the base station sends HARQ entity information correlated with a serving cell. In a specific implementation, the base station may send the HARQ entity information correlated with the serving cell when the serving cell is added or modified. The HARQ entity information includes an HARQ entity identification correlated with the serving cell.

As shown below, three exemplary and non-limiting implementations of the method in a 3GPP standard protocol are presented.

Implementation I:

```
RadioResourceConfigDedicatedSCell-r10 ::= SEQUENCE {
    -- UE specific configuration extensions applicable for an SCell
    physicalConfigDedicatedScell-r10
    PhysicalConfigDedicatedSCell-r10  OPTIONAL,
    -- Need ON
    ...,
    [[ mac-MainConfigSCell-r11 MAC-MainConfigSCell-r11
    OPTIONAL -- Cond SCellAdd
    ]]
}
MAC-MainConfigSCell-r11 ::= SEQUENCE {
    stag-Id-r11 STAG-Id-r11 OPTIONAL, -- Need
OP
    harqentity-Id-r13 HARQEntity-Id-r13 OPTIONAL,
-- Need OP
      ...
}
```

Implementation II:

SharedHarqInfoList-r13 ::=SEQUENCE (SIZE (1..maxSharedHarq)) OF
SharedHarqInfo-r13
SharedHarqInfo-r13 ::= SEQUENCE (SIZE (1..maxCell)) OF
ServCellIndex

Implementation III:

| | |
|---|---|
| SharedHarq-ToAddModList ::= | SEQUENCE (SIZE |

(1..maxSharedHarq)) OF SharedHarq-ToAddMod

| | |
|---|---|
| SharedHarq-ToReleaseList ::= | SEQUENCE (SIZE |
| (1..maxSharedHarq)) OF SharedHarq-Identity | |
| SharedHarq-ToAddMod ::= SEQUENCE { | |
| SharedHarq-Identity | INTEGER (1..m), |

```
    SharedHarqInfo-r13 ::= SEQUENCE (SIZE (1..maxCell)) OF
ServCellIndex
    ...
}
```

In step 102, the base station performs dynamic scheduling and HARQ transmission for a corresponding TB (transmission block) among serving cells according to the HARQ entity information correlated with the configured serving cell.

For example, if three serving cells SCell1, SCell2 and SCell3 are configured to be a same HARQ entity identification, it means that the base station configures the three serving cells to share the same HARQ entity. Under this configuration, for a TB, the base station can schedule the HARQ primary transmission of the TB on the SCell1 according to a network load and channel quality, while scheduling the HARQ retransmission of the TB on the SCell2 or SCell3, thereby implementing the inter-carrier dynamic HARQ transmission under the shared HARQ entity configuration.

Prior to step 101, the method may further include: the base station receives and acquires the capability information indicating whether the UE supports the multi-carrier/inter-cell dynamic HARQ transmission, or the capability information indicating whether the UE supports the shared HARQ entity. The information may be transmitted through an RRC message, for example, the information may be carried in an UE-EUTRA-Capability information element in the UE capability information. As shown below, an implementation of the UE capability information in the 3GPP standard protocol is presented.

```
UE-EUTRA-Capability-v13xy-IEs ::= SEQUENCE {
      mac-Parameters-r13 MAC-Parameters-r13
...
      nonCriticalExtension SEQUENCE { } OPTIONAL
}
MAC-Parameters-r13 ::= SEQUENCE {
      harqRetransInCells-v13xy ENUMERATED (supported) OPTIONAL,
      ...
}
```

As illustrated in FIG. 2, the operation at the user equipment side includes step 201 and step 202.

In step 201, the UE receives HARQ entity information correlated with a serving cell and sent by the base station. In a specific implementation, the UE may receive the HARQ entity information correlated with the serving cell when the serving cell is added or modified. The HARQ entity information includes an HARQ entity identification correlated with the serving cell.

An implementation of the entity identification in the 3GPP standard protocol may be as described in the above step 101 and is therefore not repeated herein.

In step 202, the UE performs the HARQ transmission for a corresponding TB (transmission block) among serving cells according to the HARQ entity information correlated with the configured serving cell.

For example, if the HARQ entity information of three serving cells SCell1, SCell2 and SCell3 are the same HARQ entity identification, the UE considers that the three serving cells share the same HARQ entity. Under this configuration, for a TB, the UE may receive the first transmission of one TB on the SCell1 according to an instruction of the base station, receive the HARQ retransmission of the TB on the SCell2 or SCell3, and jointlyly decode the HARQ transmission received on different serving cells/carriers, thereby implementing the inter-carrier dynamic HARQ transmission under the shared HARQ entity configuration.

Prior to step 201, the method may further include: the UE sends the capability information indicating whether the UE supports the multi-carrier/inter-cell dynamic HARQ transmission, or the capability information indicating whether the UE supports the shared HARQ entity. The information may be transmitted through an RRC message, for example, the information may be carried in an UE-EUTRA-Capability information element in the UE capability information. The implementation of the information in the 3GPP standard protocol may be as described above and is therefore not repeated herein.

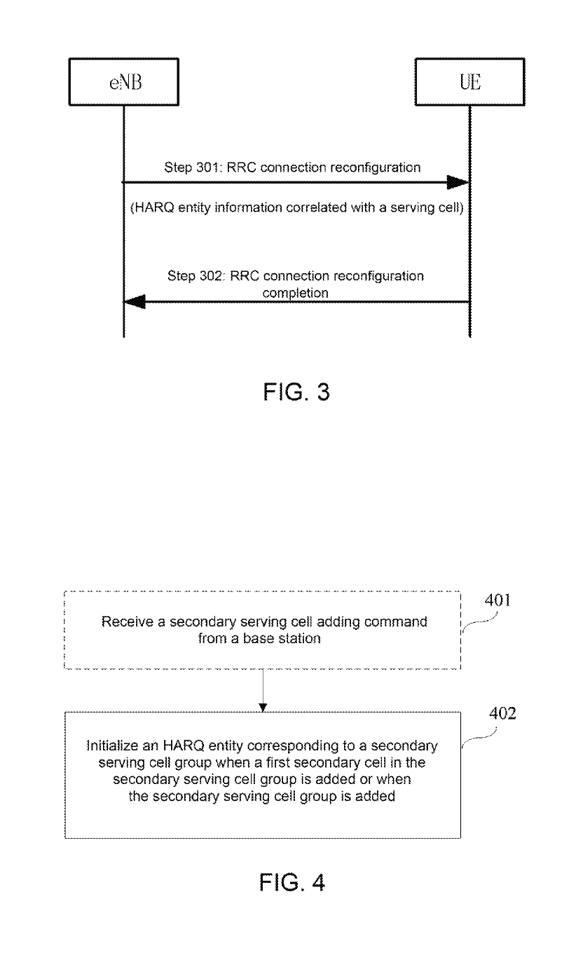

As illustrated in FIG. 3, the information exchange between the base station and the UE includes step 301 and step 302.

In step 301, the base station sends HARQ entity information correlated with a serving cell to the UE. In a specific implementation, the information may be sent through an RRC (radio resource control) message such as an RRC connection reconfiguration message, and the HARQ entity information correlated with the serving cell may be sent when the serving cell is added or modified. The HARQ entity information includes an HARQ entity identification correlated with the serving cell.

An implementation of the method in the 3GPP standard protocol may be as described in the above step 101 and is therefore not repeated herein.

In step 302, the UE receives the HARQ entity information correlated with the serving cell and sent by the base station and returns a response message to the base station, and the response message may be an RRC connection reconfiguration complete message.

Prior to step 301, the method may further include: the UE and the base station exchange the capability information indicating whether the UE supports the multi-carrier/inter-cell dynamic HARQ transmission, or the capability information indicating whether the UE supports the shared HARQ entity. The implementation of the capability information in the 3GPP standard protocol is as described above and is therefore not repeated herein.

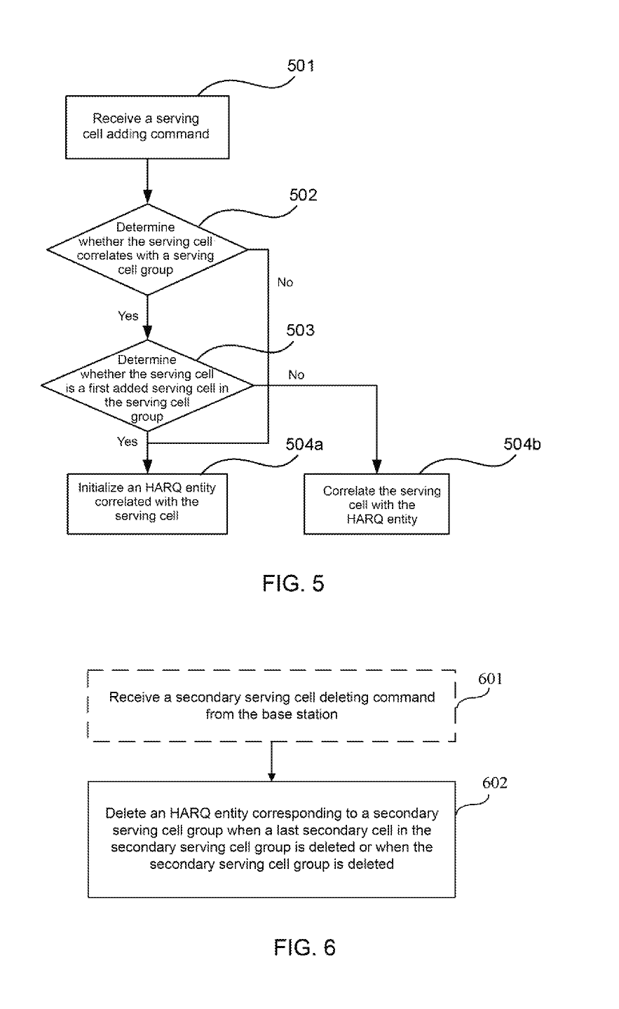

The flowchart illustrating a first embodiment of the user equipment side HARQ entity management method proposed for the aforementioned multi-carrier shared HARQ entity configuration and according to the present disclosure is described below with reference to FIG. 4 and FIG. 5. Specifically, the embodiment provides a UE side HARQ entity management method when sharing an HARQ entity and when a serving cell is added. The method can be applied to the user equipment or a medium access control (MAC) entity in the user equipment.

As illustrated in FIG. 4, the HARQ entity management method according to the first embodiment includes step 402 and optional step 401.

In step 402, the UE initializes an HARQ entity corresponding to a secondary serving cell group when a first secondary cell in the secondary serving cell group is added or when the secondary serving cell group is added.

In step 401, the UE receives a secondary serving cell adding command from the base station.

FIG. 5 is a flowchart illustrating a specific implementation of the method illustrated in FIG. 4.

Step 501: the UE receives the serving cell adding command.

Step 502: whether the serving cell correlates with a serving cell group is determined. If yes, step 503 is executed; and otherwise, step 504a is executed.

Step 503: whether the serving cell is a first added serving cell in the serving cell group is determined. If yes, step 504a is executed; and otherwise, step 504b is executed. In the present step, the adding of the first serving cell in the serving cell group can also be considered as the adding of the serving cell group.

Step 504a: the HARQ entity correlated with the serving cell is initialized.

Step 504b: the serving cell correlates with the corresponding HARQ entity.

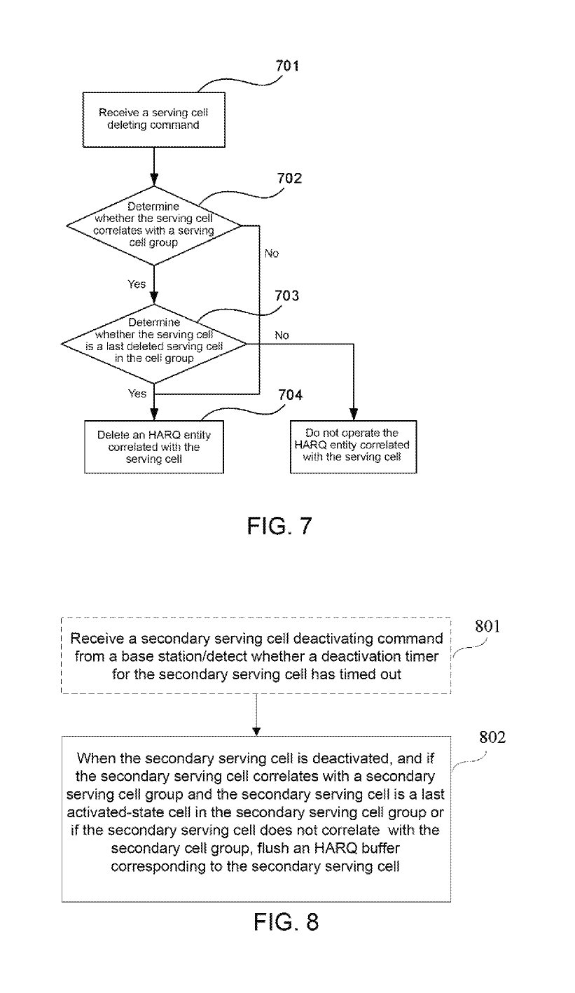

Then, a flowchart illustrating a second embodiment of a user equipment side HARQ entity management method according to the present disclosure is described with reference to FIG. 6 and FIG. 7. Specifically, the embodiment provides a UE side HARQ entity management method when sharing an HARQ entity and when a serving cell is released. The method can be applied to the user equipment or a medium access control (MAC) entity in the user equipment.

As illustrated in FIG. 6, the HARQ entity management method according to the second embodiment includes step 602 and optional step 601.

In step 602, the UE releases an HARQ entity corresponding to a secondary serving cell group when a last secondary cell in the secondary serving cell group is released or when the secondary serving cell group is released.

In step 601, the UE receives a secondary serving cell release command from the base station.

FIG. 7 is a flowchart illustrating a specific implementation of the method illustrated in FIG. 6 and specifically includes the following steps.

Step 701: the UE receives a serving cell release command.

Step 702: whether the serving cell correlates with a serving cell group is determined. If yes, step 703 is executed; and otherwise, step 704 is executed.

Step 703: whether the serving cell is a last released serving cell in the serving cell group is determined. If yes, step 704 is executed. In the present step, the release of the last serving cell in the serving cell group can also be considered as the serving cell group being released.

Step 704: the HARQ entity correlated with the serving cell is removed.

If a determination result of step 703 is No, no action is excuted to the HARQ entity correlated with the serving cell.

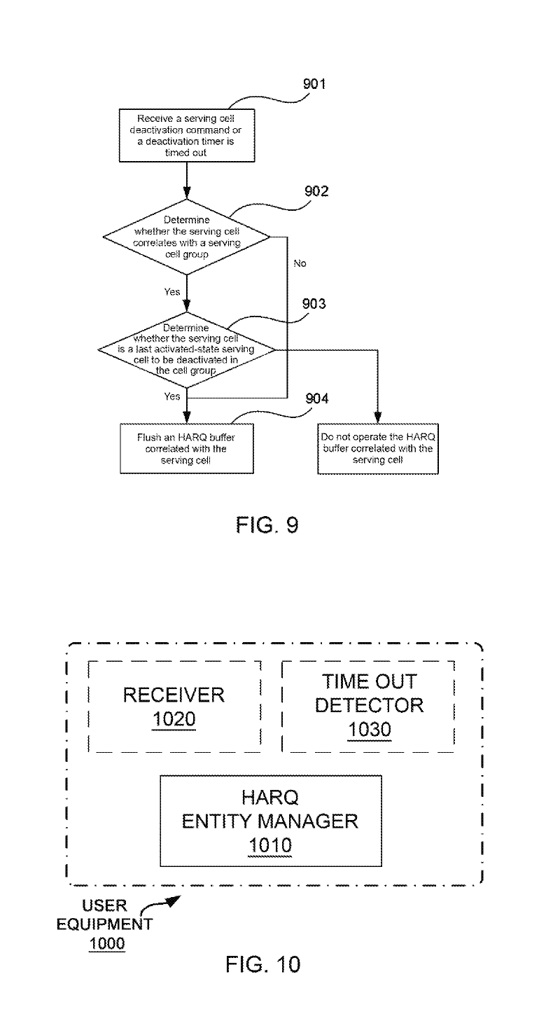

Then, a flow diagram illustrating a third embodiment of a user equipment side HARQ entity management method according to the present disclosure is described with reference to FIG. 8 and FIG. 9. Specifically, the embodiment provides a UE side HARQ buffer management method when sharing an HARQ entity and when a serving cell is deactivated. The method can be applied to the user equipment or a medium access control (MAC) entity in the user equipment.

As illustrated in FIG. 8, the HARQ entity management method according to the third embodiment includes step 802 and optional step 801.

In step 802, when the secondary serving cell is deactivated, and if the secondary serving cell correlates with a secondary serving cell group and the secondary serving cell is a last activated-state cell in the secondary serving cell group or if the secondary serving cell does not correlate with the secondary serving cell group, the UE flushes an HARQ buffer corresponding to the secondary serving cell.

In step 801, the UE receives a secondary serving cell deactivation command from the base station; or detects a deactivation timer for the secondary serving cell i timed out.

FIG. 9 is a flowchart illustrating a specific implementation of the method illustrated in FIG. 8 and specifically includes the following steps.

Step 901: the UE receives a serving cell deactivation command or a deactivation timer correlated with the serving cell is timed out.

Step 902: whether the serving cell correlates with a serving cell group is determined. If yes, step 903 is executed; and otherwise, step 904 is executed.

Step 903: whether the serving cell is the last activated-state serving cell to be deactivated in the serving cell group is determined. If yes, step 904 is executed.

Step 904: all HARQ buffers correlated with the serving cell are flushed within a predefined transmission timing interval (TTI) according to a defined timing relation. The timing relation described in step 904 is not in the scope concerned by the present invention.

If a determination result of step 903 is No, no action is excuted to the HARQ buffer.

The structural schematic diagram of a user equipment 1000 according to the present disclosure is described below with reference to FIG. 10. The user equipment 1000 corresponds to the UE side HARQ entity management method in the above first embodiment, second embodiment and third embodiment.

As illustrated in FIG. 10, the UE 1000 includes an HARQ entity manager 1010. Corresponding to the first embodiment described above, the HARQ entity manager 1010 may be configured to initialize an HARQ entity when a first secondary cell in a secondary serving cell group is added, or when the secondary serving cell is added. The UE 1000 may further include a receiver 1020, configured to receive a secondary serving cell adding command from a base station.

Corresponding to the second embodiment described above, the HARQ entity manager 1010 may be configured to release an HARQ entity corresponding to a secondary serving cell when a last secondary cell in a secondary serving cell group is released, or when the secondary serving cell group is released. The receiver 1020 may be configured to receive a secondary serving cell release command from the base station.

Corresponding to the third embodiment described above, the HARQ entity manager 1010 may be configured to flush an HARQ buffer corresponding to the secondary serving cell when the secondary serving cell is deactivated, and if the secondary serving cell correlates with a secondary serving cell group and the secondary serving cell is a last activated-state cell in the secondary serving cell group or if the secondary serving cell does not correlate with the secondary serving cell group. The receiver 1020 may be configured to receive a secondary serving cell deactivation command from the base station. The UE 1000 may further include a time-out detector 1030, configured to detect whether a deactivation timer for the secondary serving cell has timed out.

It shall be appreciated that the above embodiments of the present invention can be implemented through software, hardware or a combination of the software and the hardware. For example, various assemblies inside the base station and the user equipment in the above-mentioned embodiments can be implemented through various devices, and these devices include but are not limited to an analog circuit device, a digital circuit device, a digital signal processing (DSP) circuit, a programmable processor, an application-specific integrated circuit (ASIC), a field programmable gate array (FPGA), a complex programmable logic device (CPLD), and the like.

In the present application, the “base station” refers to a mobile communication data and control exchange center with relatively high transmitting power and relatively wide coverage area, and includes a resource allocation and scheduling function, a data receiving-transmitting function, and the like. The “user equipment” refers to a user mobile terminal, for example, a terminal device capable of performing wireless communication with the base station or a micro base station, such as a mobile phone, a notebook computer, and the like.

Furthermore, the embodiments of the present invention disclosed herein may be implemented on a computer program product. More specifically, the computer program product is one of the following products: a computer readable medium, where the computer readable medium is encoded with a computer program logic, and when being executed on a computer device, the computer program logic provides relevant operations so as to implement the above-mentioned technical solution of the present invention. When being executed on at least one processor of a computer system, the computer program logic enables the processor to execute the operations (method) described in embodiments of the present invention. This arrangement of the present invention is typically provided to be arranged or encoded on software, codes and/or other data structures on the computer readable medium such as an optical medium (for example CD-ROM), soft disk or hard disk, other mediums of firmware or micro-codes on one or more of ROM, RAM or PROM chips, or downloadable software images, shared databases and the like in one or more modules. The software, firmware or the like can be installed on the computer device, so that one or more processors in the computer device execute the technical solution described in the embodiments of the present invention.

Although the present invention has already been described in combination with preferred embodiments of the present invention, those skilled in the art shall appreciate that various modifications, replacements and changes can be made to the present invention without departing from the spirit and scope of the present invention. Therefore, the present invention shall not be limited by the above-mentioned embodiments, but shall be limited by the following claims and equivalences thereof.

1. A hybrid automatic repeat request (HARQ) entity management method executed by a user equipment or a medium access control (MAC) entity in the user equipment, comprising:
initializing an HARQ entity corresponding to a secondary serving cell group when a first secondary cell in the secondary serving cell group is added or when the secondary serving cell group is added.

2. The method according to claim 1, further comprising:
receiving a secondary serving cell adding command from a base station.

3. An HARQ entity management method executed by a user equipment or a medium access control (MAC) entity in the user equipment, comprising:
releasing an HARQ entity corresponding to a secondary serving cell group when a last secondary cell in the secondary serving cell group is released or when the secondary serving cell group is released.

4. The method according to claim 3, further comprising:
receiving a secondary serving cell release command from a base station.

5. An HARQ entity management method executed by a user equipment or a medium access control (MAC) entity in the user equipment, comprising:
flushing an HARQ buffer corresponding to the secondary serving cell when the secondary serving cell is deactivated, and if the secondary serving cell correlates with a secondary serving cell group and the secondary serving cell is a last activated-state cell in the secondary serving cell group or if the secondary serving cell does not correlate with the secondary cell group.

6. The method according to claim 5, further comprising:
receiving a secondary serving cell deactivation command from a base station; or
detecting a deactivation timer for the secondary serving cell has timed out.

7. The method according to claim 1, wherein
the secondary cells in the secondary serving cell group share a same HARQ entity.

8. The method according to claim 1, further comprising:
receiving secondary serving cell group indication information from the base station via a radio resource control (RRC) message, wherein the secondary serving cell group indication information is used for indicating an HARQ entity corresponding to the secondary cell.

9. A user equipment, comprising:
an HARQ entity manager, configured to initialize the HARQ entity when the first secondary cell in the secondary serving cell group is added, or when the secondary serving cell is added.

10. The user equipment according to claim 9, further comprising:
a receiver, configured to receive a secondary serving cell adding command from a base station.

11. A user equipment, comprising:
an HARQ entity manager, configured to release an HARQ entity corresponding to a secondary serving cell group when a last secondary cell in the secondary serving cell group is released or when the secondary serving cell group is released.

12. The user equipment according to claim 11, further comprising:
a receiver, configured to receive a secondary serving cell release command from a base station.

13. A user equipment, comprising:
an HARQ entity manager, configured to flush an HARQ buffer corresponding to the secondary serving cell when the secondary serving cell is deactivated, and if the secondary serving cell correlates with a secondary serving cell group and the secondary serving cell is a last activated-state cell in the secondary serving cell group or if the secondary serving cell does not correlate with the secondary cell group.

14. The user equipment according to claim 13, further comprising:
a receiver, configured to receive a secondary serving cell deactivation command from the base station; or
a time-out detector, configured to detect whether a deactivation timer for the secondary serving cell has timed out.

15. The user equipment according to claim 9, wherein
the secondary cells in the secondary serving cell group share a same HARQ entity.

16. The user equipment according to claim 9, wherein
the receiver receives secondary serving cell group indication information from the base station via a radio resource control (RRC) message, and
the secondary serving cell group indication information is used for indicating an HARQ entity corresponding to the secondary cell.

17. The method according to claim 1, wherein
the secondary cells in the secondary serving cell group share a same HARQ entity.

18. The method according to claim 1, further comprising:
receiving secondary serving cell group indication information from the base station via a radio resource control (RRC) message, wherein the secondary serving cell group indication information is used for indicating an HARQ entity corresponding to the secondary cell.

19. The method according to claim 3, wherein
the secondary cells in the secondary serving cell group share a same HARQ entity.

20. The method according to claim 3, further comprising:
receiving secondary serving cell group indication information from the base station via a radio resource control (RRC) message, wherein the secondary serving cell group indication information is used for indicating an HARQ entity corresponding to the secondary cell.

21. The user equipment according to claim 9, wherein
the secondary cells in the secondary serving cell group share a same HARQ entity.

22. The user equipment according to claim 9, wherein
the receiver receives secondary serving cell group indication information from the base station via a radio resource control (RRC) message, and
the secondary serving cell group indication information is used for indicating an HARQ entity corresponding to the secondary cell.

23. The user equipment according to claim 11, wherein
the secondary cells in the secondary serving cell group share a same HARQ entity.

24. The user equipment according to claim 11, wherein
the receiver receives secondary serving cell group indication information from the base station via a radio resource control (RRC) message, and
the secondary serving cell group indication information is used for indicating an HARQ entity corresponding to the secondary cell.
